(19) United States
(12) Patent Application Publication
(10) Pub. No.: US 2022/0252691 A1
(43) Pub. Date: Aug. 11, 2022

(54) POSITION DETERMINATION ON THE BASIS OF SURROUNDINGS OBSERVATIONS

(71) Applicant: Robert Bosch GmbH, Stuttgart (DE)

(72) Inventors: Narunas Vaskevicius, Stuttgart (DE); Peter Biber, Tuebingen (DE)

(21) Appl. No.: 17/618,210

(22) PCT Filed: May 29, 2020
(86) PCT No.: PCT/EP2020/064987

§ 371 Date: Dec. 10, 2021

(30) Foreign Application Priority Data
Jun. 12, 2019 (DE) 10 2019 208 504.0

(51) Int. Cl. G01S 5/02; G01C 21/00; G05D 1/02

(52) U.S. Cl. CPC G01S 5/0294; G01C 21/3807; G01C 21/3841; G01S 5/0289; G05D 1/0212

(57) ABSTRACT

A method for position determination. The method includes: recording measured data from the surroundings of a vehicle, robot, or mobile device, using at least one sensor situated on the vehicle, robot, and/or mobile device; compressing the measured data to form a compressed data item; searching for the compressed data item in a map, the map associating compressed data items at least with a position or pose in two- or three-dimensional space; in response to the compressed data item being found in the map, using the position or pose associated with the compressed data item by the map to ascertain the position or pose of the vehicle, robot, or mobile device. A method for creating a map for the position determination is also described.

### FIELD

The present invention relates to a method, with the aid of which the position or pose of a vehicle, robot, or mobile device may be ascertained from observations of the surroundings independently of permanently installed infrastructure.

### BACKGROUND INFORMATION

If vehicles and robots are to move autonomously, it is important that they are always correctly informed of their own position and orientation. This is the prerequisite for the trajectory planned for the autonomous movement being actually followed in reality, and the vehicle or the robot not colliding with objects which should not even be there according to its perception of the surroundings. Accuracies ranging from approximately 30 cm down to just a few centimeters are required here.

Satellite-based navigation systems may supply accuracies of this type only under favorable reception conditions. Multiple propagation in developed areas and shading of the visibility from the satellites, due to houses or trees, may impair the accuracy.

U.S. Patent Application Publication No. US 2017/053 060 A1, U.S. Pat. Nos. U.S. Pat. No. 8,699,755 B2 and U.S. Pat. No. 9,644,975 B2 describe methods, with the aid of which the position of a vehicle may be ascertained even without signals from satellites or other permanently installed infrastructure. Structures such as road markings are detected and compared with a digital road map. The road map may also be expanded and updated during this process.

### SUMMARY

Within the scope of the present invention, a method is provided for determining the position of a vehicle, robot, and/or mobile device. The mobile device may be, for example, a smartphone. In accordance with an example embodiment of the present invention, in the method, measured data are recorded from the surroundings of the vehicle or mobile device with the aid of at least one sensor situated at the vehicle, robot or mobile device. These measured data are compressed to form a compressed data item.

In particular, the compression to form a compressed data item may include, for example, a selection of a subset of the recorded measured data according to a predefined criterion. Only the measured data which meet the predefined criterion are then incorporated into the compressed data item.

Alternatively or in combination therewith, the compression to form a compressed data item may include, for example, an aggregation of the measured data by offsetting them against each other. An offset of this type may include, for example, the formation of a mean value or median.

The compression to form a compressed data item may also take place, for example, using a variational autoencoder. An autoencoder of this type is an artificial neural network, which generates a representation having a significantly reduced dimensionality from the input measured data and subsequently retranslates this representation. The autoencoder is trained to emulate the originally entered measured data as much as possible after the retranslation. The internal representation generated in the autoencoder, which has a reduced dimensionality, may be used as a compressed data item of the input measured data.

In accordance with an example embodiment of the present invention, the compressed data item is searched for in a map, this map associating compressed data items at least with a position or pose in two- or three-dimensional space. The term “pose” designates the combination of position and spatial orientation.

This search is not limited to the fact that the compressed data item must occur in an identical form in the map. For example, scaled, rotated and/or perspectively distorted versions of the compressed data item may also be searched for in the map. For example, the parameters of a scaling, rotation and/or distortion which result in a match of the compressed data item with an area of the map may be used to determine the position or pose of the vehicle, robot or mobile device.

In response to the compressed data item being found in the map, the position or pose associated with the compressed data item by the map is used to ascertain the position or pose of the vehicle or mobile device.

The measured data used for this purpose may include, for example, an intensity of electromagnetic radiation, which was received as the response of the surroundings to an electromagnetic scanning radiation. The electromagnetic scanning radiation may be, for example, a light beam or a radar beam, which is scanned through the surroundings. The measured data may then include, for example, a lidar or radar scan of the surroundings, which measures the intensity of the scanning radiation reflected in each case.

However, the scanning radiation does not necessarily have to have been emitted by the vehicle, robot or mobile device. For example, the sun or the moon may emit light as scanning radiation, and the light reflected from the surroundings may be absorbed as the response in the form of an image.

It has been recognized that the formation of the compressed data item and the search in the map based on this compressed data item make the recognition in the map more robust with respect to uncertainties and situation-dependent changes, to which the recording of the measured data is subject. The compressed data item is thus an abstracted form of the measured data, which evens out differences of this type between the measured data of the same setting recorded at different points in time.

If the measured data include the intensity of received electromagnetic radiation, measured data may be selected, for example, for forming the compressed data item, which indicate an intensity and/or an intensity gradient above a predefined threshold value. The compressed data item then contains only the part of the response to the electromagnetic scanning radiation which arises from the dominant features of the setting present in the surroundings. These may be, for example, buildings, other permanently mounted objects, road markings, boundaries between grass and asphalt or other arbitrary features.

While an image of a setting recorded in sunlight, for example, differs significantly from an image of the same setting recorded in moonlight, a suitable stipulation for the compression to form the compressed data item may result in that the signature of this dominant feature contained in the compressed data item is nearly identical for both images.

In contrast to the related art, the compression to form a compressed data item may take place “en bloc,” without individual features in the measured data, such as road markings, having to be first identified and classified. As a result, it is not established ahead of time which dominant features may be used for the recognition in the map.

For example, an application for controlling autonomous vehicles through a port facility, in which ground markings are essentially the only constant features, may depend primarily on ground markings as dominant features. However, where permanently installed structures exist, for example hydrants, manhole covers or underfloor shutoff valves for supply lines, the latter may also be automatically taken into account, even if their presence was not known ahead of time.

In accordance with an example embodiment of the present invention, the possibility of also recognizing the spatial orientation of the vehicle, robot or mobile device, based on the measured data, is advantageous, in particular, if the position determination is not continuously active. For example, a satellite-based navigation system does not supply any direct information about the spatial orientation. Instead, this orientation is inferred from the last tracked direction of movement. However, if the position determination was inactive for some time, for example because the vehicle or the robot was turned off, when the latter is started up again, it is not guaranteed that the orientation last ascertained is still correct. For example, a vehicle or robot may be pushed manually in the turned-off state, or it may have been rotated around its own axis. An updated piece of information about the orientation is therefore needed as soon as possible after the restart. This piece of information may be obtained on the basis of the measured data without a first movement having to be initially carried out, in which a collision may already occur.

In one particularly advantageous embodiment of the present invention, the ascertained position or pose is combined with a position or pose ascertained in a different way and/or checked for plausibility. In this way, the specific advantages of different localization methods may be combined with each other.

In open terrain without any man-made structures, for example, there are few dominant features which may be incorporated into the compressed data item and recognized in the map. A satellite-based navigation system supplies a better accuracy in the open terrain, since a direct line of sight to more satellites is available.

Conversely, many man-made ground markings exist, for example, in a port facility, at an airport or in a hall, which may be incorporated into the compressed data item, while the visibility of satellites is at least partially shaded by the building structures.

In accordance with an example embodiment of the present invention, a mutual plausibility check of different localization methods further increases the operational reliability. For example, this makes it possible to recognize whether a sensor used for recording the measured data was contaminated or was out of adjustment during routine operation, or whether the recording of the measured data is subject to a systematic error for other reasons. It is also possible to recognize whether, for example, the accuracy of a satellite-based navigation system suddenly deteriorates. For example, this accuracy may be artificially reduced at the instruction of the safety authorities without the users being warned in advance.

Alternatively or also in combination with satellite navigation, odometry, inertial navigation or normal LIDAR-based scan matching, for example, may be used as further methods for the position determination.

In one particularly advantageous embodiment of the present invention, in addition to the position or pose, the uncertainty of this position or pose is also ascertained. This information is valuable, in particular, for combining (merging) positions or poses, which were ascertained using different methods. The positions or poses ascertained using the different methods are, in particular, subject to different uncertainties if they are based on measured data collected using different physical measuring methods.

For example, an algorithm, which recognizes the compressed data item in the map, may also supply an associated covariance matrix in addition to the transformation, which transfers the compressed data item to the correct place in the map in the right orientation.

In a further particularly advantageous embodiment of the present invention, at least one actuator acting upon a dynamic system of the vehicle or robot is activated on the basis of the ascertained position or pose. This means that the ascertained position or pose acts upon the movement ultimately carried out by the vehicle or robot. In this way, the operational reliability may be increased during the automated execution of these movements. As mentioned at the outset, the probability is reduced that the actual execution of the movement is based on prerequisites other than the underlying movement planning.

In a further particularly advantageous embodiment of the present invention, the ascertained position or pose is used to ascertain an actual trajectory of the vehicle or robot. A deviation of the ascertained actual trajectory from a setpoint trajectory is calculated. An activation signal is thereafter ascertained, which, when supplied to at least one actuator acting upon a dynamic system of the vehicle or robot, probably results in a reduction of the deviation during the further travel and/or movement. Finally, the actuator is activated with the aid of this activation signal.

It has been recognized that one and the same activation of the actuator may act upon the movement of the vehicle or robot ultimately carried out in different ways, depending on the situation, due to external influences.

For example, while the wheels of a vehicle must normally be in the straight-ahead position without a steering angle so that the vehicle travels straight ahead, a countersteering may be necessary in a strong crosswind to keep the vehicle in the lane. The intensity of this countersteering depends, for example, on whether the vehicle is loaded and consequently has a larger attack surface for the crosswind. Likewise, one and the same brake pressure in a brake cylinder effectuates a different deceleration of the vehicle, depending on the road conditions.

Similar uncertainties also exist when operating robots. For example, a robot may tilt or bend when handling a heavy weight. This tilting or bending may be compensated for by correspondingly activating actuators, so that the weight is placed precisely in its preplanned position. For example, a robot may be used to stow objects in storage compartments provided for them on a shelf. The movement planning may then provide, for example, that objects move into the compartment quickly a short distance above the floor of the storage compartment to then be lowered to the floor. In this case, the tilting or bending could result in the object banging sideways against the warehouse floor, possibly damaging both the object and the shelf. However, if the orientation of the robot is detected with the aid of the described method and corrected accordingly by activating actuators, collisions of this type may be avoided.

The map in which the compressed data item is searched for may be taken from an arbitrary source. For example, it may be supplied with the vehicle, robot or mobile device, be obtained as a download or consulted via a network, for example via the Internet. Prefabricated maps may be unavailable for company grounds or halls which are inaccessible to commercial suppliers of maps of this type.

The present invention therefore also relates to a method for creating a map for determining the position of a vehicle, robot and/or mobile device.

In accordance with an example embodiment of the present invention, in this method, the vehicle, the robot or the mobile device is moved to different measurement positions within a predefined area, in which the map is to facilitate the position determination. Measured data from the surroundings of the vehicle, robot or mobile device are recorded at each measurement position. The measured data are compressed to form a compressed data item. The compressed data item is stored in the map at least in association with the measurement position.

The density and the distribution of the measurement positions should be advantageously selected in such a way that the area in which the map is to facilitate the position determination is completely recorded. The combined quantity of all recording areas, from which measured data are recorded at the individual measurement positions in each case, should thus advantageously completely cover this area. For example, a manual test drive through this area may be undertaken.

For the specific embodiment of the present invention, which data may be used as measured data and how a compression to form a compressed data item may in detail take place, all explanations in connection with the discussion of the method described above apply similarly.

In one particularly advantageous embodiment of the present invention, the compressed data item is stored in the map in association with the pose of the vehicle, robot or mobile device at the point in time of the recording of the measured data. If the compressed data item is identically found again in the map, not only the position but also the spatial orientation of the vehicle, robot or mobile device may be directly obtained herefrom.

In a further particularly advantageous embodiment of the present invention, a position or pose determined with the aid of the method described at the outset, based on the measured data and the map, is used to ascertain the measurement position and/or the pose of the vehicle, robot or mobile device at the point in time of the recording of the measured data. The map is thus also used for the position determination in an intrinsically consistent manner during its creation in a manner comparable to so-called SLAM methods (Simultaneous Localization and Mapping). In particular, an already existing map may be improved or updated in this way.

In a further particularly advantageous embodiment of the two methods of the present invention, the measured data and/or the compressed data item are converted into a point cloud, in that individual values of the measured data or the compressed data item are assigned in each case to locations in the two- or three-dimensional space where they originated.

It has been recognized that this significantly simplifies, in particular, the aggregation of measured data over a certain period of time, which, in turn, increases the accuracy of the recognition. The measured data may be simply successively added to the point cloud during the entire period of time without a particular offset being necessary. For example, if multiple different measured values are assigned consecutively to one and the same location, the point cloud then contains a separate point for each measured value, there being points having identical location coordinates. Resulting ambiguities may be resolved by the subsequent compression and/or by the downstream evaluation.

In this regard, the data type of the point cloud interacts synergistically with the formation of the compressed data item: A large portion of the recorded information is typically discarded by the compression of the measured data. To obtain a reliable statement on the position of the vehicle, robot or mobile device, it is therefore advantageous to insert a larger quantity of measured data overall at the beginning. Exactly this is facilitated by the point cloud.

A point cloud may furthermore be compressed to form a compressed data item in a particularly organic manner. For example, a predefined condition may be checked separately for each individual point. The compressed data item is then a subset of the original point cloud, which contains only those points to which the condition applies. During the compression to form the compressed data item, the data type is ultimately not changed.

Moreover, particularly usable matching algorithms are available specifically for compressed data items formed from point clouds, with the aid of which a compressed data item may be found again in a map. In other words, if both the map and the compressed data item are represented in the form of point clouds, and the compressed data item is found again in the map by matching the point clouds, the efficiency and accuracy of the position determination may be further increased. For example, a normal distributions transform (NDT), which supplies a constant and differentiable probability density, at least piece by piece, may be carried out on point clouds. Probability densities of this type may be effectively compared with each other, for example using a Newton algorithm.

In a further advantageous embodiment of the present invention, the measured data and/or the compressed data item is/are transformed into a coordinate system, in which the map is static. This additionally makes it easier to aggregate measured data over multiple measurements.

In a further particularly advantageous embodiment of the present invention, the measured data are collected over a predefined period of time and/or over a predefined distance. The collected measured data are transformed into the coordinate system, in which the map is static. The compressed data item is formed from the transformed measured data.

A certain integration thus takes place over a period of time or distance, the interval for this purpose being independent of a possible periodic cycle, in which the compression to form the compressed data item occurs, in time or distance. For example, a new compressed data item may be formed after a driving distance of 5 meters in each case, measured data from the previous 10 meters of driving distance then being taken into account in each case.

In this way, the reliability of the position determination may be further increased. In particular, the setting surrounding the vehicle, the robot or the mobile device may be recorded from multiple perspectives before the compressed data item is formed. This is helpful, in particular, to resolve ambiguities which may arise when using only one perspective.

The pose of the vehicle, the robot or the mobile device changes continuously during the collection. The coordinate system in which the measured data are recorded thus also changes continuously. To nevertheless transfer all measured data to a shared coordinate system, for example relative movement information of the vehicle, the robot or the mobile device may be recorded during the collection and used for the transformation into the shared coordinate system.

In this regard, the situation is somewhat comparable to long-exposure astrophotography. In this case, the measured data is also integrated over a certain period of time and transferred to a shared coordinate system to ultimately obtain a single good image. The coordinate system in which the recent contributions to the image are recorded changes continuously, due to the earth's rotation. This is generally compensated for by a mechanical readjustment of the camera.

In accordance with example embodiments of the present invention, the methods may be, in particular, entirely or partially computer-implemented. The present invention therefore also relates to a computer program, including machine-readable instructions, which prompt the computer to carry out one of the described methods when run on one or multiple computers. In this sense, control units for vehicles and embedded systems for technical devices, which are also able to carry out machine-readable instructions, are also to be viewed as computers.

Likewise, the present invention also relates to a machine-readable data medium and/or to a download product, including the computer program. A download product is a downloadable digital product which is transferable via a data network, i.e., by a user of the data network, which may be offered for sale in an online shop for immediate downloading.

A computer may furthermore be equipped with the computer program, with the machine-readable data medium or with the download product.

Further measures which improve the present invention are illustrated in greater detail below, together with the description of the preferred exemplary embodiments of the present invention, based on figures.

### BRIEF DESCRIPTION OF THE DRAWINGS

FIG. 1 shows an exemplary embodiment of method 100 for position determination, in accordance with the present invention.

FIG. 2 shows an exemplary embodiment of method 200 for creating a map 5, in accordance with the present invention.

FIG. 3 shows an example of a selection of measurement positions 51 through 53 and poses 51a through 53a in an area 50 for the position determination, in accordance with the present invention.

### DETAILED DESCRIPTION OF EXAMPLE EMBODIMENTS

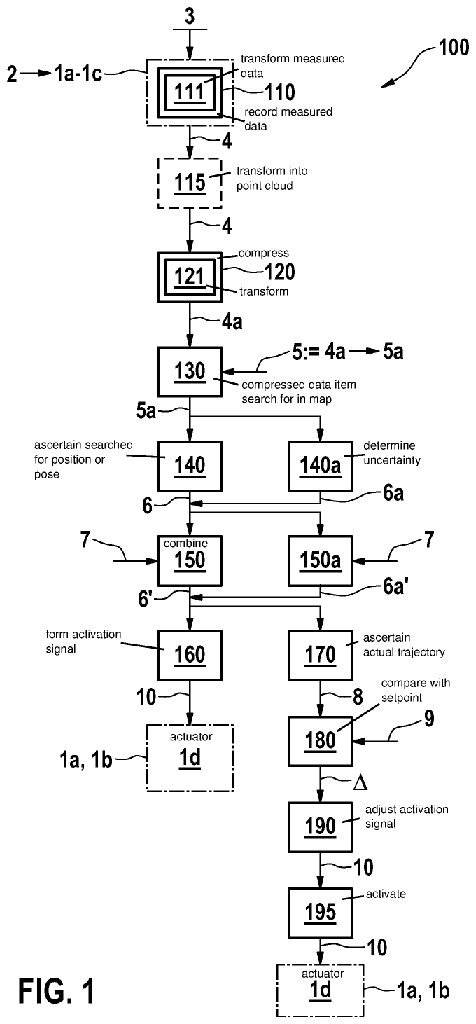

FIG. 1 shows a flowchart of an exemplary embodiment of method 100 for position determination. In step 110, measured data 4 are recorded from surroundings 2 of a vehicle 1a, a robot 1b or a mobile device 1c with the aid of at least one sensor 3 situated at vehicle 1a, at robot 1b or at mobile device 1c. According to block 111, these measured data 4 may be transformed into a coordinate system, in which map 5 used for the position determination is static. Measured data 4 may furthermore be optionally transformed into a point cloud in step 115.

In step 120, measured data 4 are compressed to form a compressed data item 4a. According to block 121, compressed data item 4a may, in turn, be transformed into a coordinate system, in which map 5 is static.

Map 5 assigns positions or poses 5a to compressed data items 4a. In step 130, compressed data item 4a is searched for in map 5. If the search is successful, position or pose 5a assigned to compressed data item 4a is used in step 140 to ascertain searched for position or pose 6 of vehicle 1a, robot 1b or mobile device 1c. In step 140a, uncertainty 6a of this position or pose may be additionally determined.

In step 150, position or pose 6 may be combined with position or pose 7 ascertained in another way and/or checked for plausibility. Position or pose 6 may be changed to a corrected position or pose 6′.

In the example illustrated in FIG. 1, this corrected position or pose 6′ is used to specifically influence the dynamics of vehicle 1a or robot 1b. However, position or pose 6 ascertained in step 140 may also be used directly for this purpose.

An activation signal 10 is formed from position or pose 6, 6′ in step 160. An actuator 1d, which acts upon the dynamics of vehicle 1a or robot 1b, is activated with the aid of this activation signal 10.

Alternatively or also in combination herewith, position or pose 6, 6′ is used in step 170 to ascertain an actual trajectory 8 of vehicle 1a or robot 1b. In step 180, this actual trajectory 8 is compared with a setpoint trajectory 9. In step 190, based on ascertained deviation A, the activation signal 10 which, when applied to actuator 1d, probably results in a reduction of deviation A during the further travel and/or movement. In other words, activation signal 10 is dimensioned in such a way that deviation A is to be adjusted therewith. In step 195, actuator 1d is activated with the aid of this activation signal 10.

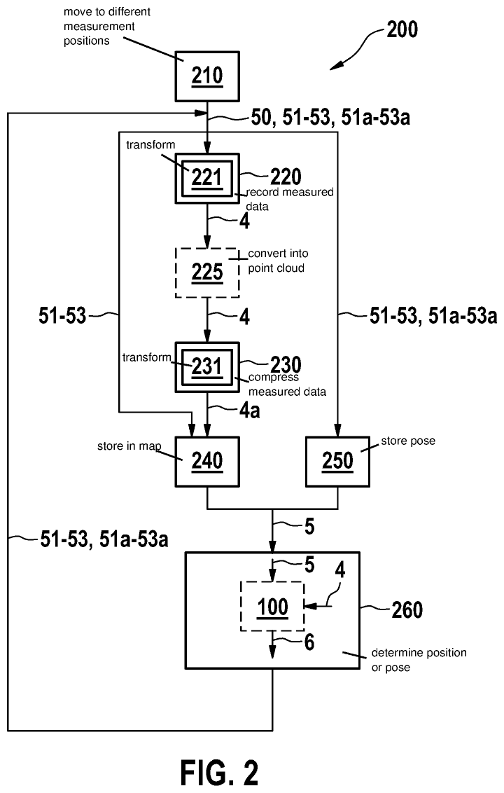

FIG. 2 shows a flowchart of an exemplary embodiment of method 200 for creating a map 5. In step 210, vehicle 1a, robot 1b or mobile device 1c is moved to different measurement positions 51 through 53 within area 50, in which map 5 is to facilitate the position determination. Vehicle 1a, robot 1b or mobile device 1c may each, in particular, adopt a different orientation in space. In particular, vehicle 1a, robot 1b or mobile device 1c may be placed in a new orientation at one of measurement positions 51 through 53 by being rotated around its own axis, so that a new pose 51a through 53a is generated at the same measurement position 51 through 53.

Measured data 4 is recorded from the surroundings of vehicle 1a, robot 1b or mobile device 1c in each measurement position 51 through 53 or in each pose 51a through 53a. According to block 221, measured data 4 may be transformed into a coordinate system, in which map 5 is static. Measured data 4 may be optionally converted into a point cloud in step 225.

In step 230, measured data 4 are compressed to form a compressed data item 4a. According to block 231, compressed data item 4a may, in turn, be transformed into a coordinate system, in which map 5 is static.

In step 240, compressed data item 4a is stored in map 5 at least in association with measurement position 51 through 53. If pose 51a through 53a of vehicle 1a, robot 1b or mobile device 1c is known at the point in time of the recording of measured data 4, compressed data item 4a may be stored in map 5 in step 250 in association with complete pose 51a through 53a, i.e., with the position and orientation at the point in time of the recording of measured data 4.

In step 260, a position or pose 6 determined on the basis of measured data 4 and map 5 with the aid of method 100 may be used to ascertain measurement position 51 through 53 and/or to ascertain pose 51a through 53a at the point in time of the recording of the measured data. Method 200 may then operate similarly to a SLAM method (Simultaneous Localization and Mapping).

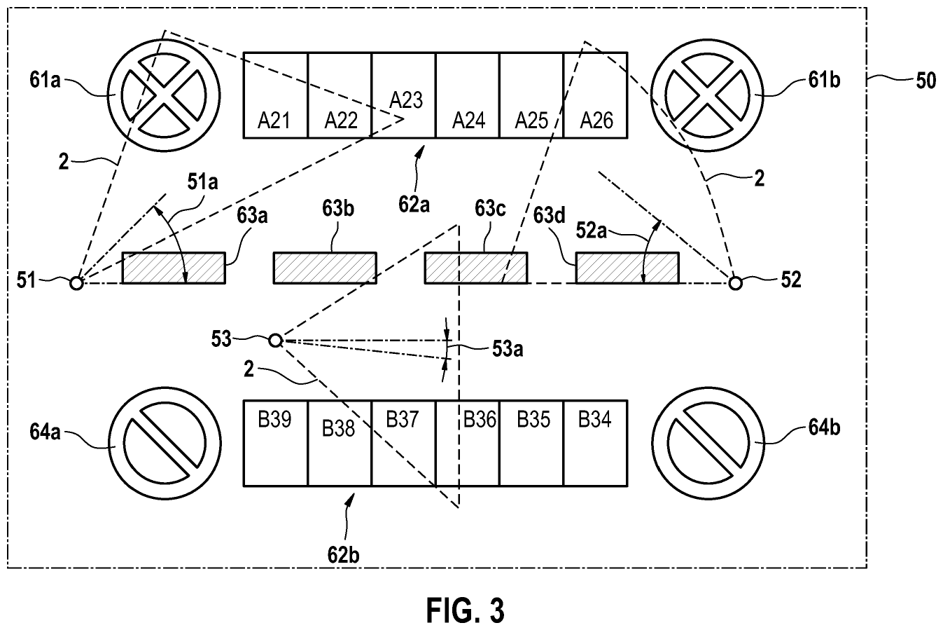

FIG. 3 shows an example of an area 50 on a port facility, on which methods 100, 200 explained above may be used. There are no permanently installed features in area 50, but only ground markings for orientation. In the example illustrated in FIG. 3, these are no-stopping markings 61a, 61b, markings 62a, 62b for container storage spots, road markings 63a through 63d, as well as no-parking markings 64a, 64b.

Three measurement positions 51 through 53 are drawn as examples. At each of these measurement positions 51 through 53, surroundings 2 are observed and measured data 4 are recorded. In FIG. 3, only the part of surroundings 2 visible to the sensors of vehicle 1a, robot 1b or mobile device 1c in each case is marked at each of measurement positions 51 through 53. This part also depends on the particular orientation of vehicle 1a, robot 1b or mobile device 1c. The orientation is contained in particular complete pose 51a through 53a.

1-17. (canceled)

18. A method for position determination of a vehicle or a robot or a mobile device, comprising the following steps:
recording measured data from surroundings of the vehicle or the robot or the mobile device using at least one sensor situated at the vehicle or robot or mobile device;
compressing the measured data to form a compressed data item;
searching for the compressed data item in a map, the map associating compressed data items at least with a position or pose in two- or three-dimensional space; and
in response to the compressed data item being found in the map, using the position or pose associated with the compressed data item by the map to ascertain the position or pose of the vehicle or the robot or the mobile device.

19. The method as recited in claim 18, wherein the ascertained position or pose is combined with a position or pose ascertained in another way and/or checked for plausibility.

20. The method as recited in claim 18, wherein, in addition to the position or pose, an uncertainty of the position or pose is also ascertained.

21. The method as recited in claim 18, wherein at least one actuator acting upon a dynamic system of the vehicle or robot is activated using an activation signal, based on the ascertained position or pose.

22. The method as recited in claim 18, wherein:
the ascertained position or pose is used to ascertain an actual trajectory of the vehicle or the robot;
a deviation of the ascertained actual trajectory from a setpoint trajectory is calculated;
an activation signal is ascertained, which, when supplied to at least one actuator acting upon a dynamic system of the vehicle or the robot, is expected to result in a reduction of the deviation during the further travel and/or movement; and
the at least one actuator is activated using the activation signal.

23. A method for creating a map for determining a position of a vehicle or a robot or a mobile device, comprising the following steps:
moving the vehicle or the robot or the mobile device to different measurement positions within a predefined area, in which the map is to facilitate a position determination;
recording respective measured data from surroundings of the vehicle or the robot or the mobile device at each respective measurement position of the measurement positions;
compressing each of the respective measured data to form a compressed data item; and
storing each of the compressed data items in the map at least in association with the respective measurement position.

24. The method as recited in claim 23, wherein each of the compressed data items is stored in the map in association with a pose of the vehicle or the robot or the mobile device at a point in time of the recording of the respective measured data.

25. The method as recited in claim 23, wherein a position or pose, determined on the basis of the measured data and the map using particular steps, is used to ascertain the measurement position and/or the pose of the vehicle or the robot or the mobile device at a point in time of the recording of the respective measured data, the particular steps including:
searching for the compressed data item in the map, the map associating compressed data items at least with a position or pose in two- or three-dimensional space; and
in response to the compressed data item being found in the map, using the position or pose associated with the compressed data item by the map to ascertain the position or pose of the vehicle or the robot or the mobile device.

26. The method as recited in claim 18, wherein the measured data include an intensity of electromagnetic radiation, which was received as a response of the surroundings to an electromagnetic scanning radiation.

27. The method as recited in claim 26, wherein those of the measured data which indicate an intensity and/or an intensity gradient above a predefined threshold value, are selected for forming the compressed data item.

28. The method as recited in claim 18, wherein the measured data and/or the compressed data item are converted into a point cloud, in individual values of the measured data and/or the compressed data item are assigned to locations in the two- or three-dimensional space from which they originate.

29. The method as recited in claim 18, wherein the measured data or the compressed data item are transformed into a coordinate system, in which the map is static.

30. The method as recited in claim 29, wherein:
the measured data are collected over a predefined period of time and/or over a predefined distance;
the collected measured data are transformed into the coordinate system, in which the map is static; and
the compressed data item is formed from the transformed collected measured data.

31. The method as recited in claim 18, wherein the map and the compressed data items are represented as point clouds.

32. A machine-readable data medium on which is stored a computer program for position determination of a vehicle or a robot or a mobile device, the computer program, when executed by one or more computers, causing the one or more computer to perform the following steps:
recording measured data from surroundings of the vehicle or the robot or the mobile device using at least one sensor situated at the vehicle or robot or mobile device;
compressing the measured data to form a compressed data item;
searching for the compressed data item in a map, the map associating compressed data items at least with a position or pose in two- or three-dimensional space; and
in response to the compressed data item being found in the map, using the position or pose associated with the compressed data item by the map to ascertain the position or pose of the vehicle or the robot or the mobile device.

33. A computer configured for position determination of a vehicle or a robot or a mobile device, the computer configured to:
record measured data from surroundings of the vehicle or the robot or the mobile device using at least one sensor situated at the vehicle or robot or mobile device;
compress the measured data to form a compressed data item;
search for the compressed data item in a map, the map associating compressed data items at least with a position or pose in two- or three-dimensional space; and
in response to the compressed data item being found in the map, use the position or pose associated with the compressed data item by the map to ascertain the position or pose of the vehicle or the robot or the mobile device.
